(19) United States
(12) Patent Application Publication
(10) Pub. No.: US 2009/0184619 A1
(43) Pub. Date: Jul. 23, 2009

(54) LED ILLUMINANTOR AND HEAT-DISSIPATING METHOD THEREOF

(75) Inventor: Chih-Ming Lai, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/198,288

(22) Filed: Aug. 26, 2008

(30) Foreign Application Priority Data
Jan. 17, 2008 (CN) 200810300140.5

(51) Int. Cl. H01K 1/58; F21V 29/00; F21V 21/00

(52) U.S. Cl. 313/13; 362/294

(57) ABSTRACT

A heat-dissipating method of a light emitting diode illuminator includes the following steps. First, the light emitting diode illuminator is provided and includes a light emitting diode, a fan apparatus, a temperature sensor and a controller. The controller is electrically connected with the fan and the temperature sensor. Second, a predetermined working temperature of the light emitting diode is defined in the controller. Third, a working temperature of the light emitting diode is sensed using the temperature sensor, and a signal of the working temperature is transmitted to the controller. Fourth, the working temperature sensed by the temperature sensor is compared with the predetermined working temperature in the controller, and the fan is adjusted by the controller to work at a suitable speed.

### BACKGROUND

1. Field of the Invention

The present invention relates to illuminators and, particularly, to a light emitting diode (LED) illuminator and a heat-dissipating method thereof.

2. Description of related art

With the continuing development of scientific technology, light emitting diodes (LEDs) have been widely used in the field of illumination due to its high brightness, long lifespan, wide color gamut and so on. LEDs generally emit visible light at specific wavelengths and generate a significant amount of heat. Generally, approximately 80-90% of the electric energy consumed by the LEDs is converted to heat, with the remainder of the electric energy converted to light. If the generated heat cannot be timely dissipated, the LEDs may overheat, and thus the performance and lifespan maybe significantly reduced.

Therefore, heat-dissipating apparatuses are applied in the illuminators to timely dissipate heat generated by the LEDs. The heat-dissipating apparatus includes a fan to induce an airflow for the purpose of cooling the LEDs and a number of fins. However, during the working process of the heat-dissipating apparatus, dust and suspending particles may exist in the surroundings of the illuminators. These dust and suspending particles may negatively impact and affect the working efficiency and lifespan of the fin of the heat-dissipating apparatus, thereby shortening the lifespan of the illuminators.

What is needed, therefore, is a LED illuminator and a heat-dissipating method thereof which can overcome the above-described problems.

### SUMMARY OF THE INVENTION

An exemplary embodiment of a heat-dissipating method of a light emitting diode illuminator includes the following steps. First, the light emitting diode illuminator is provided and includes a light emitting diode, a fan apparatus, a temperature sensor and a controller. The controller is electrically connected with the fan and the temperature sensor. The fan is controlled by the controller to work at various speeds. Second, a predetermined working temperature of the light emitting diode is defined in the controller. Third, a working temperature of the light emitting diode is sensed using the temperature sensor, and a signal of the working temperature is transmitted to the controller. Fourth, the working temperature sensed by the temperature sensor is compared with the predetermined working temperature in the controller, and the fan is controlled by the controller to work at a suitable speed according to the comparison result between the working temperature and the predetermined working temperature.

Advantages and novel features will become more apparent from the following detailed description when taken in conjunction with the accompanying drawings.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is a schematic, isometric view of a light emitting diode illuminator according to an exemplary embodiment.

FIG. 2 is a flowchart of a heat-dissipating method of the light emitting diode illuminator of FIG. 1.

FIG. 3 is a logical view of a heat-dissipating process of the light emitting diode illuminator of FIG. 1.

### DETAILED DESCRIPTION OF THE INVENTION

An embodiment will now be described in detail below and with reference to the drawings.

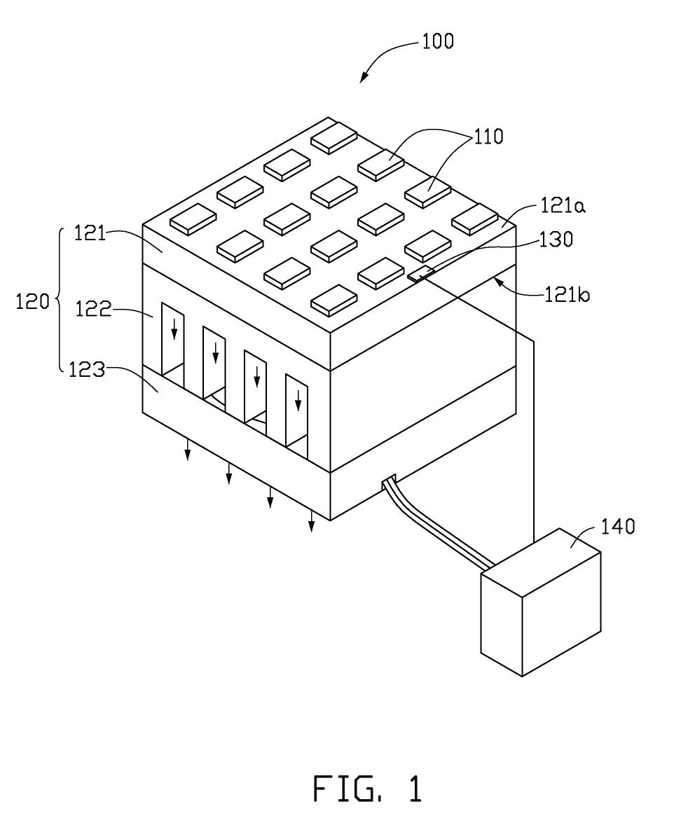

Referring to FIG. 1, a LED illuminator 100 according to an exemplary embodiment is illustrated. The LED illuminator 100 includes at least a LED 110, a heat-dissipating apparatus 120, a temperature sensor 130, and a controller 140.

The heat-dissipating apparatus 120 includes a heat-dissipating base 121, a heat sink 122 and a fan 123. The heat-dissipating base 121 includes a first surface 121a and a second surface 121b on an opposite side of the first surface 121a. The LED 110 is defined on the first surface 121a of the heat-dissipating base 121. The heat sink 122 is thermally connected to the second surface 121b of the heat-dissipating base 121. The fan 123 is coupled with the heat sink 122, and cooperates with the heat sink 122 to dissipate heat generated from the LED 110.

The temperature sensor 130 can be thermally connected to the heat-dissipating base 121 or the heat sink 122 to detect their temperatures, thereby evaluating or measuring a working temperature of the LED 110. In the present embodiment, the temperature sensor 130 is thermally connected to the heat-dissipating base 121 to detect a temperature of the heat-dissipating base 121, thereby evaluating or measuring the working temperature of the LED 110.

The controller 140 is electrically connected to the fan 123 and the temperature sensor 130, respectively. The controller 140 includes a predetermined temperature and various speeds. At the predetermined temperature, the LED 110 cannot overheat and works normally. The temperature sensor 130 senses the working temperature of the LED 110 and transmits signals of the working temperature to the controller 140. The controller 140 compares the working temperature with the predetermined working temperature, and adjusts the speed of the fan 123 according to the comparison result of the working temperature and the predetermined working temperature. Therefore, the controller 140 has functions of activating the fan 123, stopping the fan 123 and adjusting the fan 123 to work at a suitable speed. For example, the fan 123 can be controlled by the controller 140 to work at various speeds. In the present embodiment, the fan 123 has two speeds, that is, a first speed (V1) and a second speed (V2) faster than the first speed. According to the requirement of heat to be dissipated in the working process of the LED 110, the fan 123 can be controlled by the controller 140 to work in any of the first and second speeds.

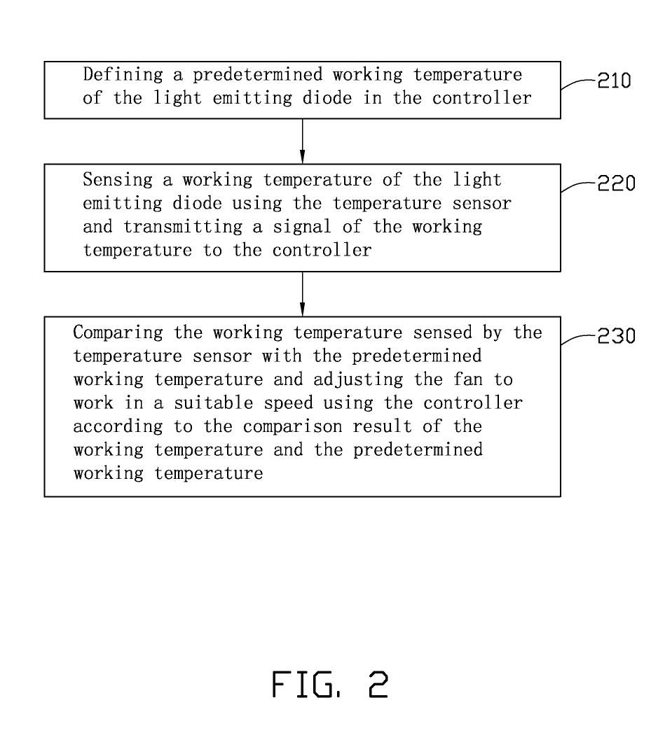

Referring to FIG. 2, an exemplary embodiment of a heat-dissipating method of the LED illuminator 100 includes: step 210, defining a predetermined working temperature of the LEDs 110 in the controller; step 220, sensing a working temperature of the LEDs 110 using the temperature sensor 130 and transmitting a signal of the working temperature to the controller 140; step 230, comparing the working temperature sensed by the temperature sensor 130 with the predetermined working temperature and adjusting the fan 123 to work at a suitable speed using the controller 140 according to the comparison result of the working temperature and the predetermined working temperature.

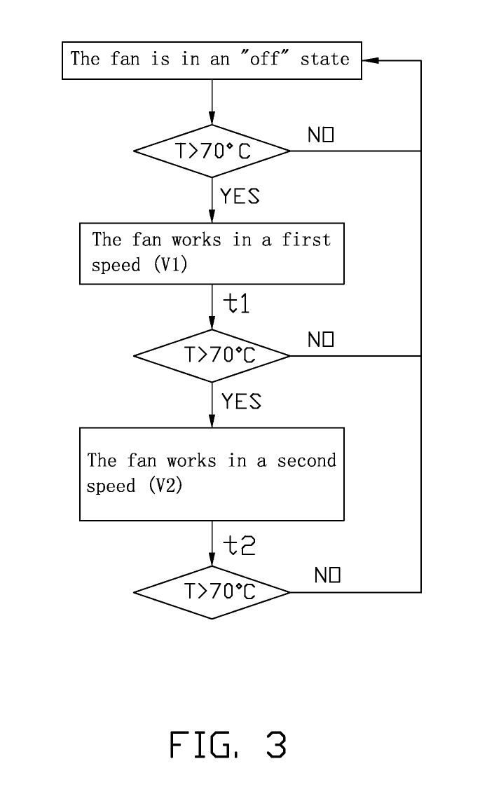

An detailed heat-dissipating process of the LED illuminator 100 is described below and with reference to FIG. 3.

In a general step 210, a predetermined working temperature (or a temperature range) of the LED 110 is defined in the controller 140 according to a working status of the LED illuminator 100. In the present embodiment, the LEDs 110 are blue LEDs. About 40% of the electric energy of the LED 110 is converted to light, that is, about 60% electric energy is converted into heat energy. Thus, when the LEDs 110 work nonstop for a long period of time, the temperature of the environment surrounding the LEDs 110 (i.e., the working temperature) rises. The LEDs 110 normally works at a temperature below 120 degrees Celsius. In the present embodiment, the predetermined working temperature is set to be 70 degrees Celsius. However, the working temperature of the LEDs 110 is difficult to be measured directly, so the predetermined working temperature and the working temperature below are acquired by measuring the temperature of the heat-dissipating base 121. That is, the predetermined working temperature and the working temperature below of the heat-dissipating base 121 are employed as the predetermined working temperature and the working temperature of the LEDs 110.

In a general step 220, the temperature sensor 130 senses the working temperature of the LED 110, and transmits a signal of the working temperature to the controller 140. Specifically, during the working process of the LED illuminator 100, the temperature sensor 130 continues to periodically sense the working temperature of the heat-dissipating base 121, and transmits the signal of the working temperature to the controller 140.

In a general step 230, the working temperature sensed by the temperature sensor 130 is compared with the predetermined working temperature using the controller 140, and the fan 123 is adjusted by the controller 140 to work at a suitable speed according to the comparison result of the working temperature and the predetermined working temperature. At the beginning of the working of the LED illuminator 100, the LEDs 110 generate a small amount of heat and the working temperature (T) of the LEDs 110 has not reach the predetermined working temperature value, i.e., 70 degrees Celsius. Under this condition, the fan 123 is in an “off” state.

When the working temperature value of the heat-dissipating base 121 sensed by the temperature sensor 130 is higher than 70 degrees Celsius, the fan 123 activates and the controller 140 adjusts the fan 123 to work at the first speed (V1). After a first period of time (t1), the working temperature of the heat-dissipating base 121 is sensed again by the temperature sensor 130, if the working temperature of the heat-dissipating base 121 is lower than 70 degrees Celsius, the fan 123 is controlled by the controller 140 to be stopped working, i.e., the fan 123 is in the “off” state. However, if the working temperature of the heat-dissipating base 121 is still higher than 70 degrees Celsius, the controller 140 adjusts the fan 123 to work at the second speed (V2). Because the second speed is faster than the first speed, the airflow of the fan 123 flows more quickly than the first speed. After a second period of time (t2), the working temperature of the heat-dissipating base 121 is sensed again by the temperature sensor 120, if the working temperature of the heat-dissipating base 121 is lower than 70 degrees Celsius, the fan 123 is controlled by the controller 140 to stop working or to work at the first speed. If the working temperature of the heat-dissipating base 121 is higher than 70 degrees Celsius, the fan 123 continuously works at the second speed until the working temperature is lower than 70 degrees Celsius. It is understood that three or more speeds can be defined in the controller 140 to adjust the fan 123 to works at three or more speeds, thereby accommodating the heat-dissipating requirement of the LEDs 110.

In the heat-dissipating method of the LED illuminator 100, the working temperature of the LEDs 110 is sensed periodically by the temperature sensor 130, and is compared with the predetermined working temperature of the LEDs 110 by the controller 1 40. According to the comparison result, the fan 123 is adjusted by the controller 140 to work at a suitable speed, for example, stops working, works at the first speed, works at the second speed. That is, the working speed of the fan 123 can be adjusted according to the quantity of the heat to be dissipated of the LEDs 110, thereby avoiding the fan 123 continuously working at a high speed. Therefore, the present heat-dissipating method prevents the LEDs 110 from overheating, simultaneously saves the energy of the fan 123 and extends the service lifetime of the fan 123. Accordingly, the service lifetime of the illuminator is extended.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light emitting diode illuminator comprising:
a light emitting diode;
a heat-dissipating apparatus comprising a heat-dissipating base, a heat sink and a fan, the heat-dissipating base comprising a first surface and an opposing second surface, the light emitting diode being mounted on the first surface of the heat-dissipating base, the heat sink being thermally connected with the second surface of the heat-dissipating base, the fan being capable of selectively working at various speeds and being configured for removing heat of the heat sink;
a temperature sensor configured for sensing a working temperature of the light emitting diode; and
a controller electrically connected with the fan and the temperature sensor, the controller configured for comparing the working temperature sensed by the temperature sensor with a predetermined working temperature and controlling the fan to work at a corresponding speed according to a comparison result between the working temperature and the predetermined working temperature.

2. The light emitting diode illuminator as claimed in claim 11, wherein the temperature sensor is thermally connected with the heat-dissipating base.

3. The light emitting diode illuminator as claimed in claim 2, wherein the temperature sensor is thermally connected to the first surface of the heat-dissipating base.

4. The light emitting diode illuminator as claimed in claim 1, wherein the temperature sensor is thermally connected with the heat sink.

5. A heat-dissipating method of a light emitting diode illuminator as claimed in claim 1, the heat-dissipating method comprising:
defining a predetermined working temperature of the light emitting diode in the controller;
sensing a working temperature of the light emitting diode using the temperature sensor and transmitting a signal of the working temperature to the controller; and
comparing the working temperature sensed by the temperature sensor with the predetermined working temperature and controlling the fan to work in a suitable speed according to the comparison result between the working temperature and the predetermined working temperature employing the controller.

6. The method as claimed in claim 5, wherein the fan is controlled by the controller to selectively work at first speed or a second speed faster than the first speed.

7. The method as claimed in claim 6, wherein if the working temperature sensed by the temperature sensor is higher than the predetermined working temperature, then the controller controls the fan to work at the first speed.

8. The method as claimed in claim 7, wherein after the fan works at the first speed for a period of time, and the working temperature sensed by the temperature sensor is less than or equal to the predetermined working temperature, then the controller controls the fan to stop working.

9. The method as claimed in claim 7, wherein after the fan works at the first speed for a period of time, and the working temperature sensed by the temperature sensor is higher than the predetermined working temperature, then the controller controls the fan to work at the second speed.

10. The method as claimed in claim 9, wherein after the fan works at the second speed for a period of time, and the working temperature sensed by the temperature sensor is less than or equal to the predetermined working temperature, then the controller controls the fan to stop working or controls the fan to work at the first speed.

11. A light emitting diode illuminator comprising:
a substrate;
a plurality of light emitting diodes electrically mounted on the substrate;
a heat sink thermally attached to an opposite side of the substrate to the light emitting diodes;
a fan for enhancing heat dissipation of the heat sink, the fan being configured for selectively operating at a first rotational speed or a second rotational speed;
a temperature sensor configured for sensing a temperature of at least one of the substrate and the heat sink; and
a controller for controlling the fan to selectively operate at the first or second rotational speed according to the sensed temperature.
